(19) United States
(12) Patent Application Publication
(10) Pub. No.: US 2015/0088627 A1
(43) Pub. Date: Mar. 26, 2015

(54) METHOD AND SYSTEMS FOR AGGREGATING MULTIPLE QUANTITIES OF GOODS, SERVICES AND PRODUCTS SUCH THAT VALUE-ADDED INCENTIVES CAN BE REQUESTED

(71) Applicants: Andrew Bate, Atlanta, GA (US); Pranav Patel, Albuquerque, NM (US); Lui King, Atlanta, GA (US); Stuart Bate, Atlanta, GA (US)

(72) Inventors: Andrew Bate, Atlanta, GA (US); Pranav Patel, Albuquerque, NM (US); Lui King, Atlanta, GA (US); Stuart Bate, Atlanta, GA (US)

(21) Appl. No.: 14/035,980

(22) Filed: Sep. 25, 2013

(51) Int. Cl. G06Q 30/02

(52) U.S. Cl. CPC G06Q 30/0217; G06Q 30/0236; G06Q 30/0224
USPC 705/14.19; 705/14.36; 705/14.25

(57) ABSTRACT

A method is disclosed for aggregating multiple quantities of services and/or multiple customers such that offers of value-added services and/or products can be requested. The method includes requesting quantities of services and/or products based upon an individual's predetermined buyer identifier. The predetermined buyer identifier comprises: a buyer profile associated with one or more third-party accounts; a buyer profile having one or more contract dates; and a buyer profile associated with one or more services and/or products. Next the method determines the availability of services and/or products from third-party suppliers based on the individual's predetermined buyer identifier. The method then determines which value-added services and/or products third-party suppliers may offer based on the individual's predetermined buyer identifier. The third-party supplier offers are matched with the individual's predetermined buyer identifier to create one or more third-party sales packages. Finally selectable lists of one or more sales packages that are unique to the individual are presented.

### FIELD OF THE INVENTION

The present invention relates generally to a method of aggregating multiple quantities of goods, services and/or products for one or more customers, such that offers of value-added services and/or products can be made, and more particularly, the method relates to aggregating a group of hotel customers and/or a group of hotel night bookings such that the customer(s) is offered value-added upgrades in proportion to the number of hotel nights booked.

### BACKGROUND OF THE INVENTION

Hotels attract different types of guests, and each guest has a different value to the hotel. However hotels have trouble measuring a guest's true value—those guests who significantly impact meaningful operating metrics such as Revenue Per Room Available (“RevPAR”), Average Daily Rate (“ADR”), total revenue and profitability.

There are currently four ways hotels try to identify the best customers and reward them through better rates or upgraded services.

The first way to attract the best guests is through corporate discounts for all of the guests a company sends to a specific hotel or hotel brand. Often times the company will mandate employees stay at these hotels to receive preferred pricing and perks, such as free Internet and no-penalty cancellations. Corporations can negotiate deals with hotels through a Request for Proposal (RFP) process. This is a negotiation between the hotel and the corporation and is usually available only to larger corporations.

The next way hotels currently reward good guests is through one-off group reservations. Often there will be an event—perhaps a conference, family reunion, wedding, or big corporate project—and a lead guest or company will complete an RFP in order to optimize the rate and benefits of the stay. Reservations of 10 or more rooms are generally handled by a special group within the hotel. The process for getting less expensive rates, or upgrades, can be time consuming and involves a series of conversations and emails, and ultimately a proposal and contract.

The third way that hotels identify best customers and reward them is through traditional loyalty programs. These programs attempt to reward a guest's decision, or reservation, by offering points, that guests can later use to earn a free night's stay, but often discount a guest's true value to the specific hotel. Guests with frequent short stays benefit, but frequent guests at a few hotels are under-rewarded.

The fourth way is to allow a third-party travel site, such as an Online Travel Agency (OTA), to find guests for a hotel. Hotels can list their rooms on OTAs and offer discounted rates; however guests are not eligible for credit for most loyalty programs when using these portals. The OTAs are disadvantageous not only for the guest, but also for the hotels, which must cut their prices to compete. Alternatively, guests can search rates directly on the Hotel websites, where he or she will get loyalty program credit for the stay; however, there is no easy visibility into all potential hotels in which the guest can earn and redeem loyalty program credit across multiple brands.

There are more guests who are valuable to the hotel—those who influence the booking decisions of others and those who can reserve a significant number of room nights at a hotel based on this influence or travel patterns and/or have a significant spend for ancillary services, food and beverage. So far, there are no effective ways for a hotel to identify this valuable guest, or for this guest to benefit from his or her buying power.

### SUMMARY OF THE INVENTION

The present invention relates generally to a method of aggregating multiple quantities of goods, services and/or products for one or more customers, and more particularly, the method relates to aggregating a group of hotel customers and/or a group of hotel night bookings such that the customer is offered value-added upgrades in proportion the number of hotel nights booked. Briefly described, aspects of the present embodiments include the following.

In a first aspect, the present embodiment provides a method for aggregating multiple quantities of services such that offers of value-added services and/or products can be made. The method comprises requesting quantities of services and/or products based upon an individual's predetermined buyer identifier. The predetermined buyer identifier comprises a buyer profile associated with one or more third-party accounts; a buyer profile having one or more contract dates; and a buyer profile associated with one or more services and/or products. Next the method determines the availability of services and/or products from third-party suppliers based on the individual's predetermined buyer identifier. The method then determines which value-added services and/or products third-party suppliers may offer based on the individual's predetermined buyer identifier. The third-party supplier offers are matched with the individual's predetermined buyer identifier to create one or more third-party sales packages. Finally, selectable lists of one or more sales packages that are unique to the individual are presented. Furthermore, an organizer may choose at least one of the groups of value-added packages from the group selectable list.

The method further includes a buyer profile associated with one or more third-party accounts comprising an individual buyer's third-party rewards program account number and profile. The buyer profile may have one or more contract dates for allowing individual buyers within the group to have individual contract dates for execution of the services and/or products requested from the third-party suppliers. The individual contract dates for execution of the services and/or products requested from the third-party suppliers can be identified by at least one of an individual predetermined buyer identifier or a third-party account. The individual predetermined buyer identifiers may be associated with each individual buyer's portion of the selected group sales package. Individual predetermined buyer identifiers allow each individual group member to be billed individually for their portion of the selected group sales package. This individual predetermined buyer identifier also makes it possible for individual group members to be rewarded individually for their portion of a selected group sales package. Furthermore, individual group members can make certain changes to their portion of the selected group sales packages based upon their individual predetermined buyer identifier.

The individual's predetermined buyer identifier can also be used to track and store historical data about the individual. For example, an individual's historical data including prior purchases, preferences and contract dates may be used to offer future incentives. The offers of value-added services and/or products may be associated with the individual's historical data.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is a flow chart of an exemplary embodiment of a method for aggregating multiple quantities of services such that offers of value added services and/or products can be made;

FIG. 2 is a flow diagram of a system of an exemplary embodiment of a method for aggregating multiple quantities of services such that offers of value added services and/or products can be made;

FIG. 3A illustrates a screen shot of a method for searching for multiple room upgrade offers using an exemplary embodiment of a method for aggregating multiple quantities of services such that offers of value-added services and/or products can be made;

FIG. 3B illustrates a screen shot of presenting multiple customer room upgrade offers using an exemplary embodiment of a method for aggregating multiple quantities of services such that offers of value-added services and/or products can be made;

FIG. 3C illustrates a screen shot of a method of entering multiple customer contact info using an exemplary embodiment of a method for aggregating multiple quantities of services such that offers of value-added services and/or products can be made;

FIG. 3D illustrates a screen shot of a method of receiving multiple customer payment transactions using an exemplary embodiment of a method for aggregating multiple quantities of services such that offers of value-added services and/or products can be made; and

FIG. 4 is a block diagram of an exemplary embodiment of a computer system.

### DETAILED DESCRIPTION

Before the present methods and systems are disclosed and described in greater detail hereinafter, it is to be understood that the methods and systems are not limited to specific methods, specific components, or particular implementations. It is also to be understood that the terminology used herein is for the purpose of describing particular aspects and embodiments only and is not intended to be limiting.

As used in the specification and the appended claims, the singular forms “a,” “an,” and “the” include plural referents unless the context clearly dictates otherwise. Similarly, “optional” or “optionally” means that the subsequently described event or circumstance may or may not occur, and the description includes instances where the event or circumstance occurs and instances where it does not.

Throughout the description and claims of this specification, the word “comprise” and variations of the word, such as “comprising” and “comprises,” mean “including but not limited to,” and are not intended to exclude, for example, other components, integers or steps. “Exemplary” means “an example of” and is not intended to convey an indication of preferred or ideal embodiment. “Such as” is not used in a restrictive sense, but for explanatory purposes.

Disclosed herein are components that can be used to perform the disclosed methods and systems. It is understood that when combinations, subsets, interactions, groups, etc. of these components are disclosed that although specific reference to each various individual and collective combinations and permutations cannot be explicitly disclosed, each is specifically contemplated and incorporated herein, for all methods and systems. This applies to all aspects of this specification including, but not limited to, steps in disclosed methods. Thus, if there are a variety of additional steps that can be performed it is understood that each of the additional steps can be performed with any specific embodiment or combination of embodiments of the disclosed methods.

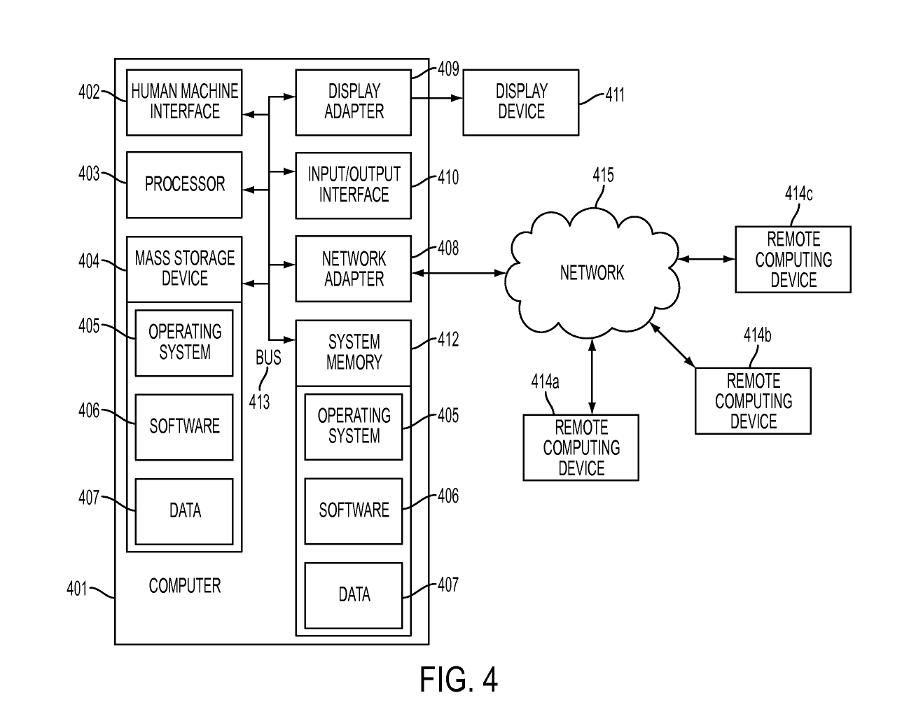

As will be appreciated by one skilled in the art, the methods and systems may take the form of an entirely new hardware embodiment, an entirely new software embodiment, or an embodiment combining new software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, non-volatile flash memory, CD-ROMs, optical storage devices, and/or magnetic storage devices. An exemplary computer system is detailed in the discussion of FIG. 4 below.

Embodiments of the methods and systems are described below with reference to block diagrams and flowchart illustrations of methods, systems, apparatuses and computer program products. It will be understood that each block of the block diagrams and flow illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

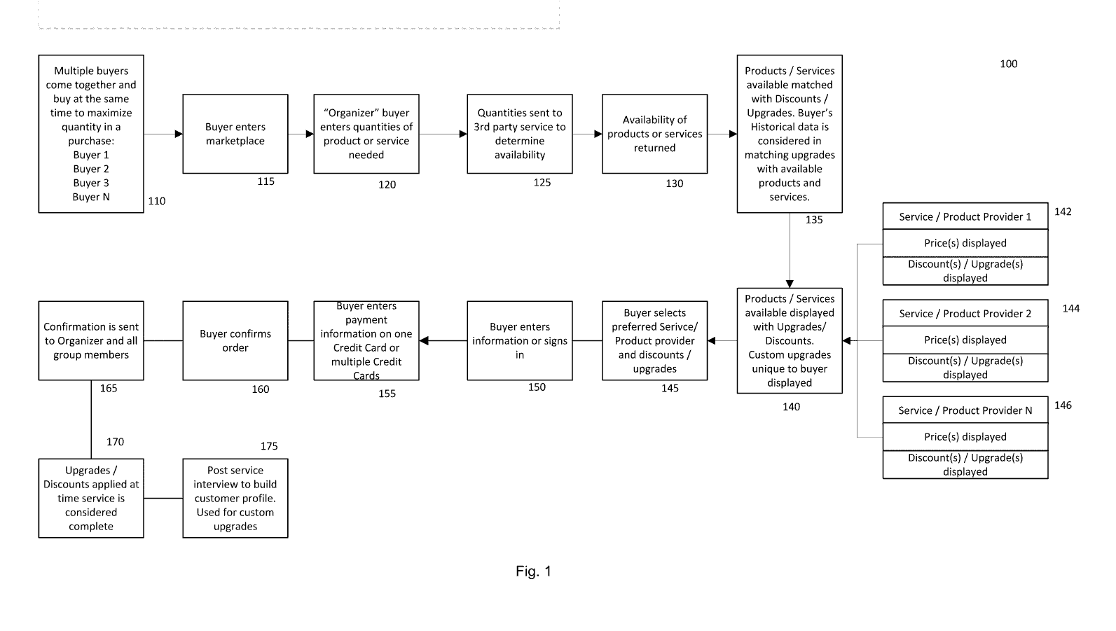

FIG. 1 is a process flow diagram that illustrates the various aspects of an exemplary embodiment in which the present methods and systems can operate. The present disclosure relates to methods and systems for a method for aggregating multiple quantities of services such that offers of value-added services and/or products. Those skilled in the art will appreciate that present methods may be used in systems that employ both digital and analog equipment, as well as digital and analog interactions. One skilled in the art will also appreciate that provided herein is a functional description and that the respective functions can be performed by software, hardware, or a combination of software and hardware.

Turning now to FIG. 1, in the process flow diagram 100 of an exemplary embodiment of a method for aggregating multiple quantities of services such that offers of value-added services and/or products. In the process flow diagram 100, an exemplary embodiment of the method being used to book an upgraded hotel stay is illustrated. Beginning at step 110, at least one buyer or multiple buyers (buyer 1-buyer N) seeking a hotel stay can come together at one time to book multiple night stays at a single hotel or brand of hotels using the service. In an embodiment a single buyer can enter the marketplace to purchase multiple quantities of goods and/or services (e.g. multiple hotel night stays) if the quantity is relatively significant. In an alternative embodiment, multiple buyers 1-N may enter the marketplace at the same time. For simplicity, this process flow diagram 100 will focus on the purchasing power of a group of buyers 1-N. By coming together at once, buyers 1-N can leverage their group buying power to maximize their potential value to a service provider, while simultaneously seeking value-added services based on the spending power of the group. The method next moves to step 115.

At step 115, the group of buyers 1-N enters the marketplace by either connecting to a webpage, mobile app, making a telephone call, in-person or via an e-commerce site. In an exemplary embodiment, an Internet based e-commerce site is provided for users to log into so that buyers 1-N can leverage their purchasing power. In the exemplary embodiment discussed in the following steps, buyers 1-N can log into an e-commerce site or mobile application, where their combined purchasing power can be aggregated and leveraged. The method then moves to step 120.

At step 120, an “organizer” or lead buyer, for example buyer 1, begins the process of searching for hotel nights for all the other buyers 2-N. In an exemplary embodiment, the “organizer” knows each buyers dates and travel plans and goes into the market place to book each buyer's 1-N hotel stay. Each buyer's 1-N hotel stay may be different. Each buyer may stay for a different length of time and check in or check out on different days from the other buyers. Therefore, stays may be aggregated over multiple hotel nights within a single time period. The organizer, armed with this information may enter all of these stays into the marketplace or e-commerce site such that the total number of hotel night stays can be aggregated. In an alternative embodiment, the “organizer” may be a single buyer who is purchasing multiple hotel night stays over the course of a month, for example. The total number of nights the single buyer is seeking to purchase may also be aggregated for value-added purchasing power. For example, a group of five buyers purchasing five hotel nights each, would have a combined total of twenty-five hotel nights. Similarly a single buyer purchasing five different, five night hotel stays, would also have his/her proposed purchase aggregated into a total of twenty-five hotel nights. Once the actual number or quantity of goods and services is known, the method then moves on to step 125.

Next at step 125, once the total number of hotel night stays being purchased by buyers 1-N are known (or total quantity of goods and services being purchased by an individual or group is known), this total is presented to a number of third-party suppliers to determine if they can accommodate the buyer(s)' requests. The method then moves on to step 130.

Once the third-party suppliers have had an opportunity to review their inventories of available rooms and/or goods and services, they may present their results the market-place portal. In an exemplary embodiment, only suppliers who can accommodate the organizer's total request are allowed to present their results. In an alternative embodiment, third-party suppliers who are only able to accommodate a portion of an organizer's request may be allowed to present partial results. Next, the method moves on to step 135.

At step 135, third-party suppliers consider the total quantity and value of goods and services sought by the organizer and seek to match these quantities with various incentive packages the third-party suppliers may have. These third-party suppliers seek to offer the organizers value-added incentives in an effort to make their products and/or service a better value for the buyers 1-N. Value-added incentives could include a variety of “extras” or “upgrades,” which may sway the purchasing decisions of the organizer and/or buyers 1-N. Using the hotel example, certain third-party suppliers may have a standard package of incentives to offer an organizer and/or buyer based upon the number of hotel nights booked. Similarly, other suppliers may have a standard upgrade incentive to offer organizers or buyers based on the quantity of goods and services booked. In the hotel example, these packages of value-added incentives are defined and stored on the e-commerce site. Customized packages may be based upon selected preferences in a buyer's predetermined buyer identifier or buyer profile. In another embodiment, customized packages may also be based upon a buyer's predefined preferences selected for the buyer's third-party loyalty rewards account, which can be associated with a predetermined buyer identifier. Therefore, it is possible that a third-party supplier can offer each buyer 1-N in a group, their own individual packages of value-added incentives. Therefore, every buyer 1-N within a group is not required to take the same package of value-added incentives. In fact each buyer within a group can be offered a different package of incentives. Furthermore, there can be multiple third-party suppliers offering multiple value-added incentive packages to the various buyers 1-N. Once the packages of value-added incentives have been determined, the method can move to step 140

These packages of value-added incentives are presented to the various buyers 1-N at step 140. In an exemplary embodiment, an “organizer” may book a combined total of 200 hotel night stays for a group. In response, a first third-party hotel provider 142 may offer the buyers; bonus loyalty points, free Internet access, and free parking as an incentive to get the “organizer” to select their product offering. Meanwhile, a second third-party hotel provider may offer the buyer's bonus loyalty points, free breakfast, a spa package and a theater package in an effort sway the organizer's decision 144. An additional third-party hotel provider may offer the buyers free parking, free breakfast and free Internet access in exchange for their booking 146. The incentive package offerings from each supplier, along with the nightly room rate, are presented to the organizer or buyers 1-N at step 140. The method then moves to step 145.

Once the buyers 1-N and/or organizer have been presented with a list of options containing one or more value-upgraded incentives, the buyers 1-N and/or organizer can select which option best meets their needs at step 145. In an embodiment, the organizer and/or buyers 1-N can select from the list of options using a web or e-commerce portal, phone conversation with a customer service agent, mobile device application, and the like. Once the organizer and/or buyers 1-N have selected one of the third-party supplier's value-added packages, the method can move on to step 150.

At step 150, the organizer and/or buyers 1-N can log into the e-commerce system and enter their account information. In an embodiment, this step can occur once the organizers and/or buyers 1-N initially access the e-commerce site via the Internet. Alternatively, this step can be presented after the third-party offers are presented. In another embodiment, this step can be presented once the buyers begin the process of paying for their value-added packages of goods, services and/or products. Once the organizers and/or buyers 1-N have logged into the e-commerce system, the method moves on to step 155.

At step 155, the organizer and/or buyers 1-N can enter their payment information for the selected value-added package. In the exemplary embodiment, the organizer and/or buyers 1-N can enter their credit card or other payment information to purchase their value-added package. In one embodiment, a single total purchase price can be presented such that the organizer or a single buyer can purchase the value-added packages for each member of the group. In an alternative embodiment, each of the buyers 1-N can enter their payment information separately, so that they can each receive a separate confirmation number and are offered individual control over their individual reservations at this point. Once the payment information has been made, the method moves on to step 160.

At step 160, buyers 1-N and/or organizer can confirm their purchase. This is the buyer's last opportunity to make changes to their request before it is confirmed with a selected third-party supplier. Each individual buyer may later make changes to their individual reservation; however, any changes may ultimately affect the final package of value-added incentives for each buyer 1-N within the group. Once the purchase of value-added incentives has been confirmed, the method moves on to step 165.

At step 165, the e-commerce site sends a confirmation message to the organizer, buyer, or each of the buyers 1-N within the group. The confirmation message may be in the form of an email, text (short message service (SMS) or media message service (MMS)), phone call, letter, etc. The confirmation message can be a generic message to the group of buyers 1-N or a custom message tailored to each buyer 1-N. In an exemplary embodiment, each buyer 1-N receives a personalized confirmation message with their payment information, details regarding their selected value-added package, and one of more confirmation (identification) numbers related to their purchase. In the hotel example, each buyer would receive a message indicating their contract dates (check in and check out dates), total cost, list of value-added incentives, reservation number and/or confirmation number, and the like. The method then moves on to step 170.

At step 170, the transaction is considered complete and the method relinquishes performance of the value-added package contract to the third-party suppliers for performing the agreed upon services with the buyers 1-N. Therefore, the method is considered substantially complete at this point. Optionally, the method can move on to step 175.

At step 175, buyers 1-N and/or organizers can be queried after the performance of their goods, services and/or products are compete so that feedback can be gathered in order to improve e-commerce services. For example, historical data may be gathered for each buyer 1-N and associated with each buyer's predetermined identifier or buyer profile such that improvements may be made to the kinds of packages offered to each buyer. For example, if a buyer historically chooses a hotel package that includes free parking over a package that includes triple rewards points, then future incentive packages from third-party suppliers may be more heavily weighted towards packages that include parking. This historical purchasing data may be stored and associated with an individual buyer's profile or predetermined identifier and referenced by the e-commerce site for future use. The method may query each buyer after their transaction (or hotel stay) is completed to gain feedback regarding what the buyers found to be valuable regarding their experience with the e-commerce site and hotel stay experience. Furthermore, historical data can also include a buyer's social network profile data, travel history data, travel preference data, and travel feedback data. The method can also gather historical data from a buyer's social network profile including positive or negative reviews or associations with third-party travel providers, location data associated with buyer pictures or check-ins on social network sites, and the like. The method is complete once the historical and feedback data is stored.

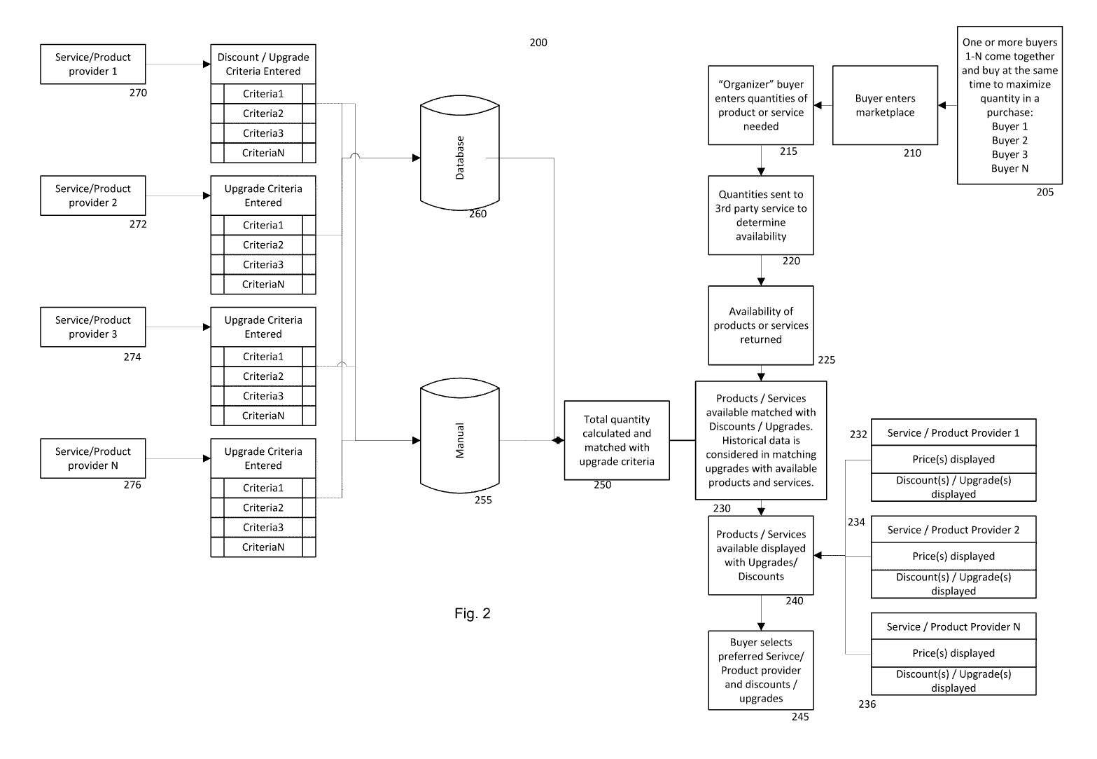

Turning now to FIG. 2, the system of providing value-added services via an e-commerce site 200 is presented. In the system at step 205, one or more buyers 1-N come together to maximize their purchasing power by entering the marketplace at the same time. In an alternative embodiment, a single buyer making a relatively large purchase or a series of smaller purchases may enter the marketplace at step 205. The system then moves to step 210.

At step 210, the buyer(s) enter the market place by directing their Internet browsers to an e-commerce site, by logging into an e-commerce site or mobile app, and/or by calling a customer service number. The buyer(s) may have an account containing a buyer profile or a predetermined buyer identifier containing a database of the buyer's preferences or previous purchases and/or other historical data. The buyer profile or predetermined identifier may include third-party loyalty program accounts numbers. Information from these third-party loyalty programs may be imported into the e-commerce and/or uploaded to the associated third-party suppliers such that a better list of value-added options may be presented to the buyers 1-N. The information in a buyer's profile may be used to improve services and offerings to the buyer(s). Once the buyer(s) have contacted the e-commerce site or mobile app, the system moves to step 215.

One or more buyers 1-N among a group of buyers may designate an “organizer,” at step 215. The organizer can serve as an agent of the other buyers, entering information, data and selecting a value-added package or series of packages for the group's purchase. In an exemplary embodiment, the organizer enters all of the hotel travel information, check-in, check-out dates, etc. for the group. The organizer enters all of the information a third-party supplier would need in order to determine the type of value-added packages to offer the individual buyer or group of buyers. Once this information has been entered, the system moves on to step 220.

The organizer-requested quantities of goods, services and/or products are presented to third-party suppliers at step 220. The third-party suppliers will query their databases and consider the dates, types, and quantities of goods, services and/or products to determine if they could fulfill the organizer's request. The system then moves to step 225.

At step 225, the third-party suppliers send an update to the e-commerce portal with the results of their query. The results can be presented via the e-commerce portal to the buyers regarding the third-party's ability to fulfill the organizer's request. Once the third-party has determined that they could fulfill the organizer's request, the system moves on to step 230.

At step 230, the third-party suppliers match their available goods, services, and/or products with upgrades based on buyer preferences from a buyer's selections, a buyer's profile or a buyer predetermined identifier that the buyer uses to enter the marketplace. The third-party suppliers can consider a number of factors when matching the organizer's requests to a package of value-added incentives. These may include the total quantity, value, and/or types of goods, services, and products requested. Once a number of matches have been made, the system moves to step 235.

At step 240, one or more third-party suppliers are able to present their matched goods, services and/or products with the value-added incentive packages to the organizer and/or group of buyers 1-N. In an embodiment, this list is presented to the user via the e-commerce site; however, it may also be presented to the buyer verbally, via a mobile web app, and/or other methods. In a further exemplary embodiment, in a hotel application for example, one or more service providers 232-236 are able to present their rates, hotel night stay availability and packages of value-added incentives to the organizer and/or buyers 1-N. Once these options are presented to the organizer and/or buyers 1-N, the system moves on to step 245.

Finally the organizer and/or buyers 1-N are able to select a value-added package from the presented list of goods, services and/or products in step 245. The organizer and/or buyers 1-N are able to complete the transaction once a value-added package has been selected.

At step 250, after the organizer and/or buyers 1-N have entered their requests for goods, services and/or products at step 215, the system passes the processing to a server for matching third-party suppliers with the organizer's and/or buyers 1-N requests for goods, services and/or products. Once the system has determined at step 225 that it has available goods, services and/or products these available goods, services and/or products are matched with one or more value-added incentive packages from one or more third-party service providers 270-276. The server queries a database 260 of various third-party service providers and their criteria for offering value-added upgrade packages to buyers. Each of the third-party service providers 270-276 may have differing criteria for the types and kinds of package they may offer. The packages offered by the third-party service providers may be selected via an automated process or a manual process 255.

At step 255, the system allows for a third-party supplier to manually select the type of incentive packages that are offered. This process may also be selected via an automated process based on the organizer and/or buyer's 1-N predetermined buyer identifiers and/or one or more buyer profiles. Once one or more third-party service providers have determined the types of packages they can offer, the system presents these results to the users at step 240.

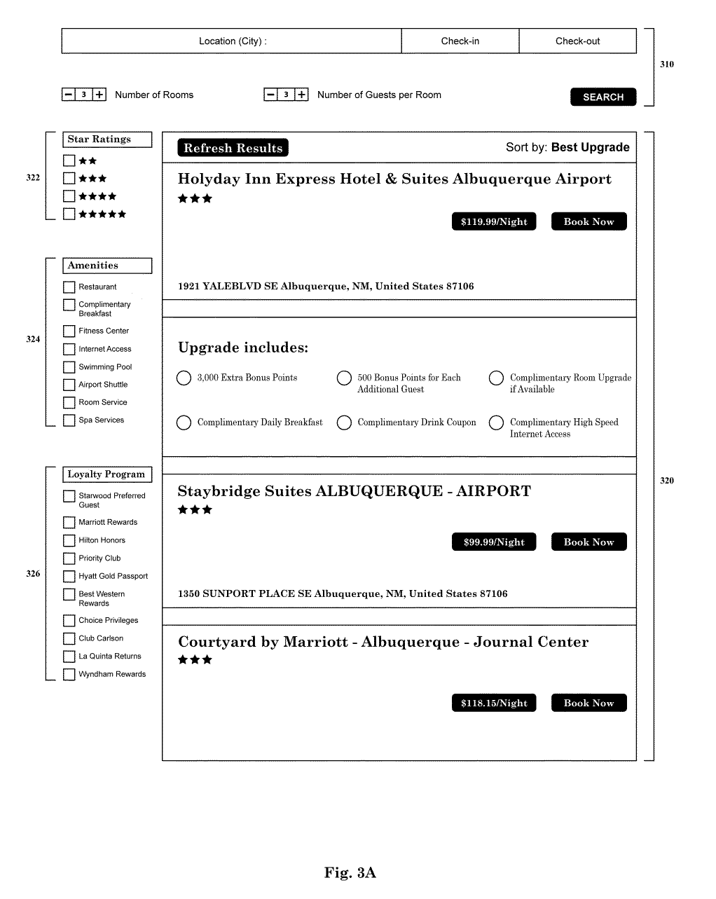

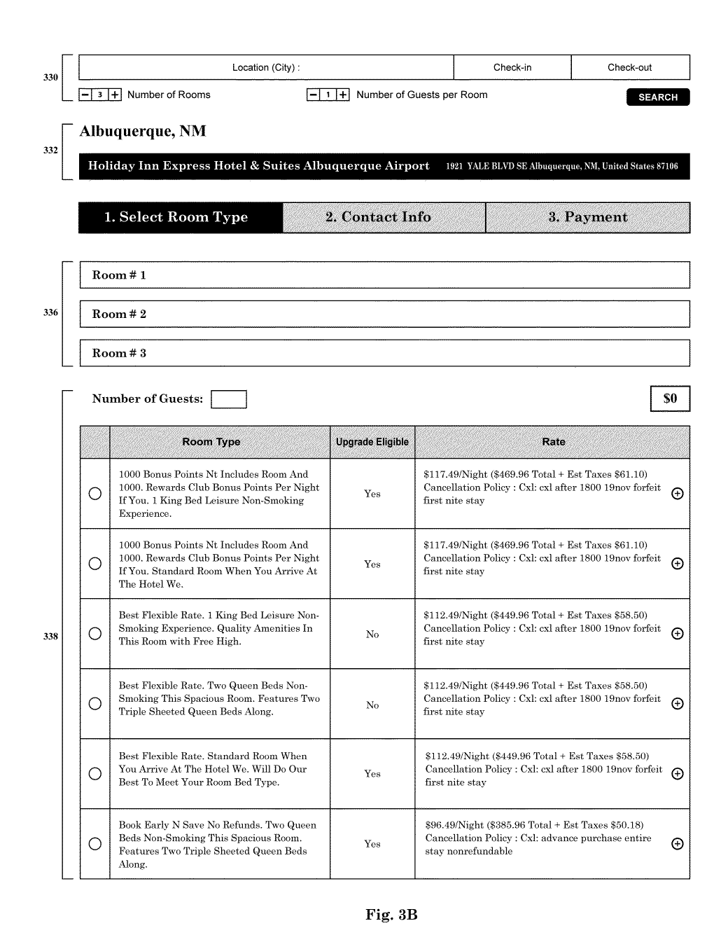

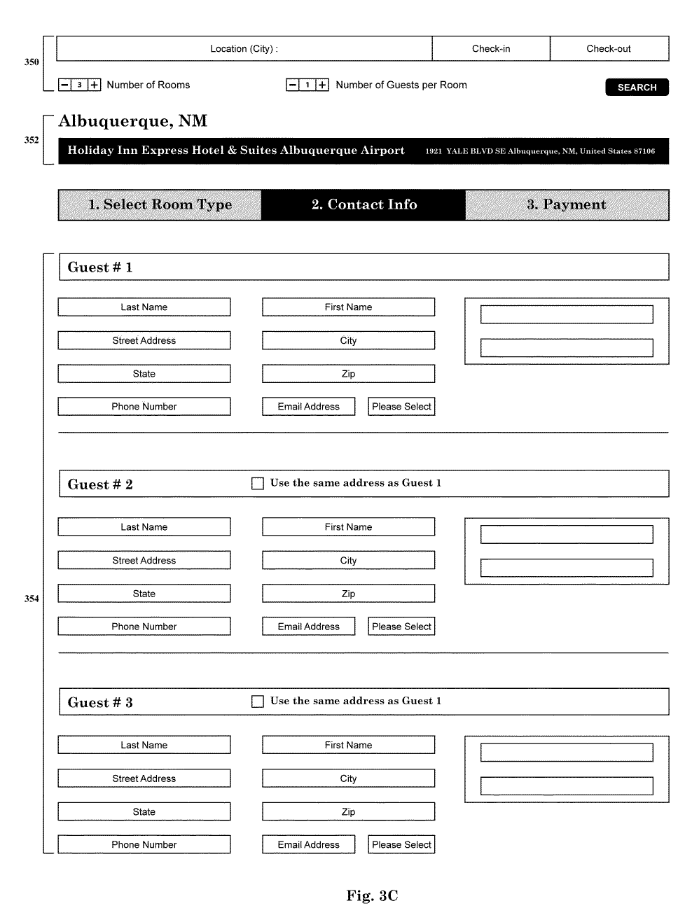

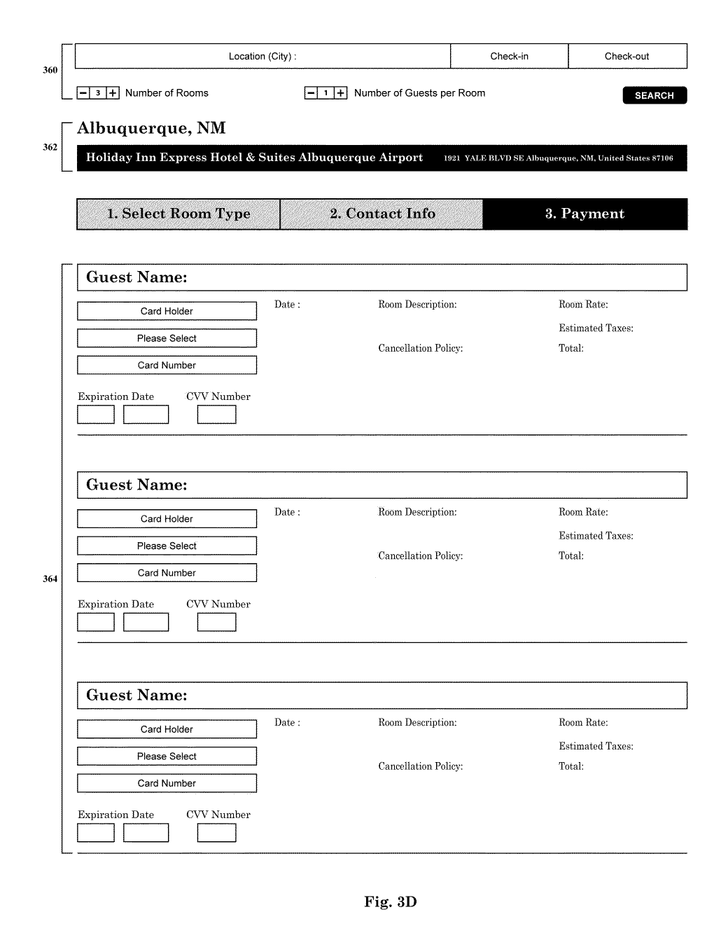

Turning next to FIGS. 3A-3D, we find illustrated screen shots of an exemplary embodiment of a method for aggregating multiple quantities of hotel services such that offers of value-added incentives, services and/or products. Although the example illustrates the booking of hotel rooms, the method could comprise the grouping of any product and/or service. Starting with FIG. 3A, the method at step 310, the organizer logs on the e-commerce website, Internet portal, mobile app, etc. Once the organizer enters the site, the organizer can request the type of service, in this case a hotel room, and parameters of the services sought. In the example, the organizer has requested a hotel room in Albuquerque, NM for four nights. Here the organizer has requested three rooms during this time period. Therefore, three different rooms, for three different guests, for four nights can be aggregated into twelve hotel room nights. The organizer can further customize his request to a specific brand of hotel 320, quality of hotel by selecting the various star ratings 322, amenities 324, and loyalty program 326. The results of the search listing one or more third-party hotels are presented at step 320. The web page in FIG. 3A next moves on to the web page in FIG. 3B.

Next in FIG. 3B, an one embodiment, the method presents the organizer with the previously selected parameters at step 330 as well as, the currently selected hotel in step 332. In this example, the organizer has selected the Holiday Inn Express. As a result of the aggregation of the twelve hotel nights, the buyer's and organizer's preferences and historical data, the organizer and other buyers in the group are presented with three rooms at step 336. Each of the rooms and upgrades can be further customized in step 338. Therefore, each room can have a different level of upgrades, pricing, size, and the like. However, the types of upgrades presented to the guests can be based on current and historical data, including the number of hotel nights booked by the group and each individual guest previously stored upgrade preferences. The web page FIG. 3B next moves on to the web page at FIG. 3C.

Next in FIG. 3C, the method at step 350 presents the organizer with the previously selected parameters at step and the currently selected hotel and rooms in step 352. Next in an embodiment, the organizer and/or one or more guest buyer's contact information can be entered at step 354. In the exemplary embodiment, the organizer can enter the contact information for each individual hotel guest (buyer). In a further embodiment each individual guest buyer may enter their personal information themselves at their own private computer terminal. For example, each individual buyer can be provided with a reservation code where they can go on to the e-commerce portal and enter their individual contact information. Once the contact information is entered, the web page in FIG. 3C moves on to the web page in FIG. 3D.

At FIG. 3D, the method presents the organizer with the previously selected parameters at step 360 and the currently selected hotel and rooms at step 362. In an exemplary embodiment, the e-commerce site can request payment at step 364. In the exemplary embodiment, the organizer can enter the payments for each individual hotel guest (buyer). In an alternative embodiment, individual guest buyers can enter their own payment information at their own private computer terminals. For example, each individual buyer can be provided with a reservation code where they can go to the e-commerce portal and enter their individual payment information. Once the payment information has been entered, the room(s) are booked. Once the payment information is entered and the rooms are booked, the transaction at the e-commerce site is complete.

Turning now to FIG. 4, one skilled in the art will appreciate that the systems and methods disclosed herein can be implemented via a general-purpose computing device in the form a computer 401. The components of the computer 401 can comprise, but are not limited to, one or more processors or processing units 403, a system memory 412, and a system bus 413 that couples various system components including the processor 403 to the system memory 412. In the case of multiple processing units 403, the system can utilize parallel computing.

The system bus 413 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Private Branch Exchange (PBX) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 413, and all buses specified in this description can also be implemented over a wired or wireless network connection and each of the subsystems, including the processor 403, a mass storage device 404, an operating system 405, software 406, data 407, a network adapter 408, system memory 412, an input/output interface 410, a display adapter 409, a display device 411, a human machine interface 402, can be contained within one or more remote computing devices 414a,b,c at physically separate locations, connected through buses of this form, in effect implementing a fully distributed system.

The computer 401 typically comprises a variety of computer readable media. Exemplary readable media can be any available media that is accessible by the computer 401, comprising both volatile and non-volatile media, as well as, removable and non-removable media. The system memory 412 comprises computer readable media in the form of volatile memory, such as random access memory (RAM), and/or non-volatile memory, such as read only memory (ROM). The system memory 412 may contain data such as media, video, audio, or other data 407 and/or program modules such as operating system 405 and software 406 capable of manipulating, translating, transcoding, or otherwise editing the data 407 that are immediately accessible to and/or presently operated on the by the processing unit 403.

In another aspect, the computer 401 can also comprise other removable/non-removable, volatile/non-volatile computer storage media. By way of example, FIG. 4 illustrates a mass storage device 404, which can provide non-volatile storage of computer code, computer readable instructions, data structures, program modules and other data for the computer 401. For example, a mass storage device 404 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 404, including by way of example, an operating system 405 and the e-commerce portal software 406. Each of the operating system 404 and the e-commerce portal software 406 (or some combination thereof) can comprise elements of the programming and the e-commerce portal software 406. Media, video, audio, or other data 407 can be stored in any of one or more databases known in the art. Examples of such databases comprise, DB2®, Microsoft® Access, Microsoft® SQL Server, Oracle®, MySQL, PostgreSQL, and the like. The databases can be centralized or distributed across multiple systems. Examples of hosted VoIP PX software include Asterisk®, FreeSwitch®, and Microsoft Lync® server software.

In another aspect, the user can enter commands and information into the computer 401 via client device or an input device (not shown). Example of such input devices comprise, but are not limited to, a keyboard, pointing device (e.g., a “mouse”), a microphone, a joystick, a scanner, tactile input devices such as gloves, and other body coverings, and the like. These and other input devices can be connected to the processing unit 403 via a human machine interface 402 that is coupled to the system bus 413, but can be connected by other interface and bus structures, such as a parallel port, game port, and IEEE 1394 Port (also known as a Firewire port), a serial port, or a universal serial bus (USB).

In yet another aspect, a display device 411 can also be connected to the system bus 413 via an interface, such as a display adapter 409. It is contemplated that the computer 401 can have more than one display adapter 409, and the computer 401 can have more than one display device 411. For example, a display device can be a monitor, an LCD (Liquid Crystal Display), or a projector. In addition to the display device 411, other output peripheral devices can comprise components such as speakers (not shown) and a printer (not shown), which can be connected to the computer 401 via input/output interface 410. Any step and/or result of the methods can be output in any form to an output device. Such output can be any form of visual representation, including but not limited to, textual, graphical, animation, audio, tactile, and the like. The display 411 and computer 401 can be part of one device or separate devices.

The computer 401 can operate in a networked environment using logical connections to one or more remote computing devices 414a,b,c. By way of example, a remote computing device can be a personal computer, portable computer, smartphone, softphone, client device, a server, a router, a network computer, a peer device or other common network node, and so on. Logical connections between the computer 401 and remote computing device 414a,b,c can be made via a network 415, such as a local area network (LAN) and or a general wide area network (WAN). Such network connections can be through a network adapter 408. A network adapter 408 can be implemented in both wired and wireless environments. Such networking environments are conventional and commonplace in dwellings, offices, enterprise-wide computer networks, intranets, and the Internet.

For purposes of illustration, application programs and other executable program components such as the operating system 405 are illustrated herein as discrete blocks, although it is recognized that such programs and components reside at various times in different storage components of the computing device 401, and are executed by the data processor(s) of the computer. An implementation of media manipulation software 406 can be stored on or transmitted across some form of computer readable media. Any of the disclosed methods can be executed by computer readable instructions embodied on computer readable media. Computer readable media can be any available media that can be accessed by a computer. By way of example and not meant to be limiting, computer readable media can comprise “computer storage media” and “communications media.” “Computer storage media” comprises volatile and non-volatile, removable and non-removable media implemented in any methods or technology for storage of information such as computer readable instructions, data structures, program modules, or other data. Exemplary computer storage media comprises, but is not limited to RAM, ROM, EEPROM, flash memory or memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence (AI) techniques such as machine learning and iterative learning. Examples of such techniques include, but are not limited to, expert systems, case-based reasoning, Bayesian networks, behavior-based AI, neural networks, fuzzy systems, evolutionary computation (e.g. genetic algorithms), swarm intelligence (e.g. ant algorithms), and hybrid intelligent system (e.g. expert interference rules generated through a neural network or production rules from statistical learning).

In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an Application Programming Interface (API), reusable controls, or the like. Such programs may be implemented in a high level procedural or object-oriented programming language to communicate with a computer system. However, the program(s) can be implemented in assembly or machine language. In any case, the language may be a compiled or interpreted language, and it may be combined with hardware implementations.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices might include PCs, network servers, mobile phones, softphones, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method of aggregating multiple quantities of services such that offers of value-added services and/or products can be made, the method comprising:
requesting quantities of services and/or products based upon an individual's predetermined buyer identifier comprising:
a buyer profile associated with one or more third-party accounts,
a buyer profile having one or more contract dates, and
a buyer profile associated with one or more services and/or products,
determining availability of services and/or products from third-party suppliers based on the individual's predetermined buyer identifier,
offering value-added criteria for determined available services and/or products from third-party suppliers based on the individual's predetermined buyer identifier,
matching offered value-added criteria from third-party suppliers with the individual's predetermined buyer identifier to create one or more third-party sales packages, and
presenting a selectable list of one or more sales packages that are unique to the individual.

2. The method according to claim 1, wherein the buyer profile associated with one or more third-party accounts comprises an individual buyer's third-party rewards program account number and profile.

3. The method according to claim 1, wherein the buyer profile having one or more contract dates allows individual buyers within the group to have individual contract dates for execution of the services and/or products requested from the third-party suppliers.

4. The method according to claim 3, wherein the individual contract dates for execution of the services and/or products requested from the third-party suppliers can be identified by at least one of an individual predetermined buyer identifier or a third-party account.

5. The method according to claim 1, wherein an organizer may choose at least one of the group sales packages offered.

6. The method according to claim 5, wherein the individual predetermined buyer identifier may be associated with each individual buyer's portion of the selected group sales package.

7. The method according to claim 6, wherein individual group members can be billed individually for their portion of the selected group sales package, based upon their individual predetermined buyer identifier.

8. The method according to claim 6, wherein individual group members can be rewarded individually for their portion of the selected group sales package based upon their individual predetermined buyer identifier.

9. The method according to claim 6, wherein individual group members can make certain changes to their portion of the selected group sales packages based upon their individual predetermined buyer identifier.

10. The method according to claims 1, wherein an individual's predetermined buyer identifier is associated with an individual's historical data including prior purchases, preferences and contract dates.

11. The method according to claim 10, wherein the offer of value-added services and/or products may be associated with the individual buyer's historical data

12. A method of aggregating multiple quantities of services and/or multiple customers such that offers of value-added incentives and/or products can be requested, the method comprising:
associating a group of at least two or more buyers of services and/or products based upon each buyer's individual predetermined buyer identifiers comprising:
a buyer profile associated with one or more third-party accounts,
a buyer profile having one or more contract dates, and
a buyer profile associated with one or more value-added criteria,
requesting one or more value-added incentives and/or products by the associated group of buyers based upon one or more preferences indicated by each individual buyer's predetermined buyer identifiers,
determining availability of the requested one or more value-added incentives and/or products from third-party suppliers for the associated group,
offering from third-party suppliers value-added incentives and/or products for the associated group's request,
matching offered value-added incentives and/or products from third-party suppliers with available quantities of services and/or products requested by the associated group to create one or more group sales packages, and
presenting value-added incentive offerings that are unique to the group.

13. The method according to claim 12, wherein the buyer profile associated with one or more third-party accounts comprises an individual buyer's third-party rewards program account number and profile.

14. The method according to claim 12, wherein the buyer profile having one or more contract dates allows individual buyers within the group to have individual contract dates for execution of the services and/or products requested from the third-party suppliers.

15. The method according to claim 14, wherein the individual contract dates for execution of the services and/or products requested from the third-party suppliers can be identified by at least one of an individual predetermined buyer identifier or a third-party account.

16. The method according to claim 12, wherein an organizer may choose at least one of the group sales packages from value-added incentive offerings.

17. The method according to claim 16, wherein the individual predetermined buyer identifier may be associated with each individual buyer's portion of the selected group sales package.

18. The method according to claim 17, wherein individual group members can be billed individually for their portion of the selected group sales package, based upon their individual predetermined buyer identifier.

19. The method according to claim 17, wherein individual group members can be rewarded individually for their portion of the selected group sales package based upon their individual predetermined buyer identifier.

20. The method according to claim 17, wherein individual group members can make certain changes to their portion of the selected group sales packages based upon their individual predetermined buyer identifier.

21. The method according to claim 12, wherein an individual's predetermined buyer identifier is associated with an individual's historical data including prior purchases, preferences and contract dates.

22. The method according to claim 21, wherein the offer of value-added services and/or products may be associated with the individual's historical data.

23. The method according to claim 21, wherein historical data also includes a buyer's social network profile data, travel history data, travel preference data, and travel feedback data.

24. The method according to claim 23, wherein historical data includes data collected from a buyer's social network including positive or negative reviews or associations with third-party travel providers, location data associated with buyer pictures or check-ins on social network sites, and the like.
